(19) United States
(12) Patent Application Publication
(10) Pub. No.: US 2019/0383692 A1
(43) Pub. Date: Dec. 19, 2019

(54) PLUMBING DETECTION SYSTEM

(71) Applicant: Gentex Corporation, Zeeland, MI (US)

(72) Inventors: William L. Tonar, Holland, MI (US); Kurtis L. Geerlings, Zeeland, MI (US); Robert R. Turnbull, Holland, MI (US)

(73) Assignee: Gentex Corporation, Zeeland, MI (US)

(21) Appl. No.: 16/438,932

(22) Filed: Jun. 12, 2019

Related U.S. Application Data
(60) Provisional application No. 62/685,436, filed on Jun. 15, 2018.

(51) Int. Cl. G01M 3/24

(52) U.S. Cl. CPC G01M 3/243

(57) ABSTRACT

A plumbing detection system includes a detector configured to be coupled to a fluid system which includes a pulse generator configured to emit a pulse into a fluid within the fluid system. A pulse receiver is configured to detect a reflected pulse. A transmitter and a base station is configured to be coupled to the fluid system. The base station includes a receiver in communication with the transmitter and is configured to cause a reduction of a flow of the fluid within the fluid system in response to the receiver receiving a signal from the transmitter of the detector.

### CROSS REFERENCE TO RELATED APPLICATIONS

This application claims the benefit of and priority to U.S. Provisional Patent Application No. 62/685,436, filed on Jun. 15, 2018, entitled Plumbing Detection System, the entire disclosure of which is hereby incorporated herein by reference.

### FIELD OF THE DISCLOSURE

The present disclosure generally relates to detection systems, and more specifically to plumbing detection systems.

### BACKGROUND OF THE DISCLOSURE

Leaks in fluid lines due to failures of components may result in damage to equipment proximate to and structures housing the fluid lines. Such failures may result from phase changes (e.g., freezing) of liquids in the fluid lines and/or through the failure of one or more components. Further, damages of such failures may be exacerbated by extended time periods occurring between failure and detection of the failure.

### SUMMARY OF THE DISCLOSURE

According to one aspect of this disclosure, a plumbing detection system may comprise: a detector configured to be coupled to a fluid system, the detector comprising: a pulse generator configured to emit a pulse into a fluid within the fluid system; and a transmitter in communication with the pulse generator; and a base station configured to be coupled to the fluid system; wherein the base station may comprise a receiver in communication with the transmitter; and wherein the base station may be configured to cause a reduction of a flow of the fluid within the fluid system in response to the receiver receiving a signal from the transmitter of the detector.

The detector further may comprise a pulse receiver configured to detect a reflected pulse. The pulse generator, the pulse receiver, and the transmitter may all be in communication with one another. The plumbing detection system further may comprise a second detector in communication with configured to be coupled to a fluid system. The second detector may comprise: a second pulse generator configured to emit a pulse into the fluid within the fluid system; and a second transmitter; wherein the base station may be configured to be in communication with the second transmitter.

The plumbing detection system may further comprise a processor in communication with the pulse receiver. The processor may be configured to determine whether a phase change has occurred in the fluid of the fluid system. The processor may be further configured to cause a signal to be generated and transmitted to at least one of the base station and an external receiver upon a determination that a phase change has occurred in the fluid of the fluid system.

The pulse may be an audio frequency of from about 0.1 Hz to about 20,000 Hz. The pulse may be an audio frequency of from about 0.1 Hz to about 1 GHz. The fluid may be water. The fluid system may be a plumbing system. The transmitter may be a wireless transmitter. The base station may be configured to terminate the flow of the fluid within the fluid system in response to the receiver receiving the signal from the transmitter of the detector. The base station may comprise a base transmitter configured to transmit a base signal to an external receiver. The external receiver may be a cell phone tower. The base station may be coupled to a valve or a controller of a fluid source.

A plumbing detector configured to be coupled to a fluid system, may comprise: a pulse generator configured to emit a pulse into a fluid within the fluid system; a pulse receiver configured to detect at least one of a reflected pulse and a transmitted pulse, and in communication with the pulse generator; a processor in communication with the pulse receiver; and a controller in communication with the processor. The pulse generator and the pulse receiver may be embodied in a piezo-electric element. The processor may be configured to determine whether there has been a change in the reflected pulse; and the processor may be configured to selectively cause the controller to stop fluid flow within the fluid system in response to information received from the pulse receiver. The fluid may be water, and the fluid system may be a plumbing system. The processor may be configured to: compare a received pulse to a previously received pulse; and determine whether there has been a change in the reflected pulse received by the pulse receiver. The plumbing detector may be configured to generate a signal in response to a change in the reflected pulse received by the pulse receiver. The plumbing detector further may comprise a transmitter in communication with an external receiver, the transmitter configured to transmit a signal to the external receiver upon a change in the reflected pulse received by the pulse receiver. The pulse may be emitted in response to the detector detecting a change in the fluid system.

These and other features, advantages, and objects of the present disclosure will be further understood and appreciated by those skilled in the art by reference to the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a schematic view of a plumbing detection system coupled with a fluid system.

### DETAILED DESCRIPTION OF EMBODIMENTS

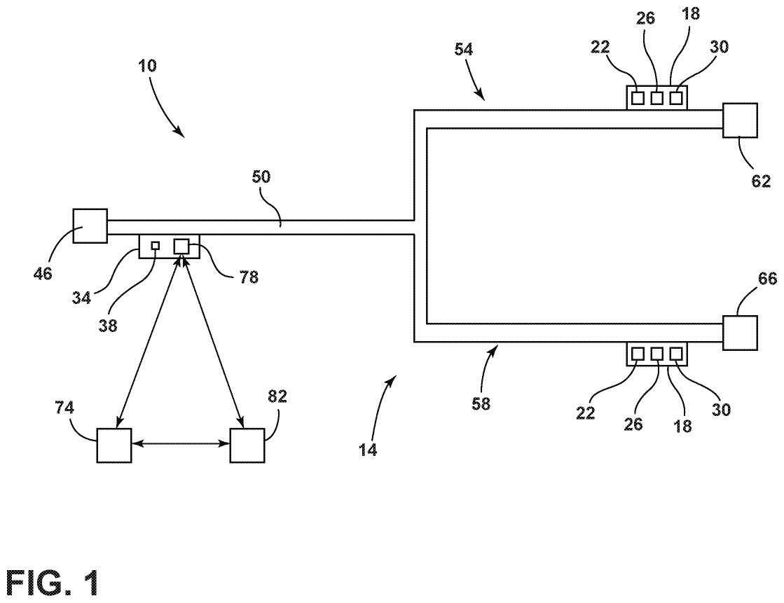

Referring now to FIG. 1, depicted is a plumbing detection system 10 configured to be used in operation with a fluid system 14. The plumbing detection system 10 includes a detector 18 configured to be coupled to the fluid system 14. The detector 18 includes a pulse generator 22. The pulse generator 22 is configured to emit a pulse into a fluid within the fluid system 14. The detector 18 also includes a pulse receiver 26 configured to detect a reflected pulse.

According to various examples, the pulse generator 22 and the pulse receiver 26 are coupled together, integrated with one another and/or are the same component. In some embodiments, the pulse generator 22 and the pulse receiver 26 may be embodied in a piezo-electric element (not shown). The detector 18 also includes a transmitter 30. The plumbing detection system 10; also includes a base station 34 configured to be coupled to the fluid system 14. The base station 34 includes a receiver 38 in communication with the transmitter 30. The base station 34 is configured to cause a reduction of a flow of the fluid within the fluid system 14 in response to the receiver 38 receiving a signal from the transmitter 30 of the detector 18. It will be understood that the base station 34 may additionally or alternatively be configured to cause a reduction or termination of the flow of the fluid in the fluid system 14 through a signal generated exterior to the plumbing detection system 10 (e.g., a cell phone, a server running a program which alerts an owner of the fluid system 14 to terminate the fluid flow, etc.).

The fluid system 14 is configured to transfer or convey one or more fluids therethrough. For example, the fluid system 14 may be configured to convey a liquid or a gas. According to various examples, the fluid carried by the fluid system 14 is water. According to various examples, the fluid system 14 may be a home or commercial plumbing system. The fluid system 14 may include a fluid source 46, a main line 50 and one or more branches. The fluid source 46 is fluidly coupled with the main line 50 and is configured to supply the fluid from an exterior of the fluid system 14 to the main line 50 of the fluid system 14. In home or commercial plumbing examples of the fluid system 14, the fluid source 46 may be the entry point of a municipal or other source of water to a building.

The main line 50 in turn supplies the fluid to the branches. In the depicted example, the fluid system 14 includes a first branch 54 and a second branch 58, but it will be understood that the fluid system 14 may include more than two branches. The first branch 54 may terminate at a first outlet 62 and the second branch 58 may terminate at a second outlet 66. It will be understood that use of the term “branch” as used herein is intended to encompass any part of the fluid system 14 other than the main line 50. Further, it will be understood that each of the branches may include a plurality of components (e.g., linear sections, coupling portions, elbows, etc.) without departing from the teachings provided herein. The first and second branches 54, 58 may each have one outlet, or one or more of the branches may have one or more outlets. In home and commercial uses, the first and second outlets 62, 66 may include a sink, a sprinkler, toilet, clothes washing machine, dishwashing machine, faucet, sprinkler system, vent and/or other outlet which may release the fluid within the first and/or second branches 54, 58. It will be understood that the first and/or second branches 54, 48 and/or the first and/or second outlets 62, 66 may also be part of a heating or cooling system for the structure housing the fluid system 14.

The detector 18 is configured to couple to the fluid system 14 at a variety of locations. For example, the detector 18 may be coupled to the main line 50, the first branch 54, the second branch 58, the first outlet 62 and/or the second outlets 66. According to various examples, the plumbing detection system 10 may include a plurality of detectors 18 at one or in a plurality of locations of the fluid system 14. The detectors 18 may be positioned externally to the components of the fluid system 14 (e.g., coupled to the exterior of a pipe), internally to the components of the fluid system 14 (i.e., in contact with the fluid) and/or integrated into one or more components of the fluid system 14 including the base station 34.

According to various examples, one or more of the detectors 18 includes the pulse generator 22. The pulse generator 22 is configured to emit the pulse into the fluid of the fluid system 14. According to various examples, the pulse may be used to measure or detect properties of the fluid in the fluid system 14. Pulse generator 22 may be directly coupled to any component of the fluid system 14 or may have one or more materials between the pulse generator 22 and the fluid system 14. Such materials may be a conductive medium configured to transmit the pulse such as metals, propylene glycol, glycerin, polymers and/or combinations thereof. According to various examples, the pulse may be an audio frequency. For example, the audio frequency may be from about 0.1 Hz to about 20,000 Hz or from about 0.1 Hz to about 1 GHz or any and all values and ranges therebetween. In audio frequency examples, the pulse may be audible (i.e., about 20 Hz to about 20 KHz) or inaudible (i.e., intrasonic or ultrasonic). Additionally or alternatively, the pulse may be an electronic or magnetic pulse. It will be understood that a variety of different (e.g., frequency, duration, type, etc.) pulses may be utilized based on the specific feature (e.g., temperature, distance, integrity, fluid flow direction, fluid flow volume, etc.) of the fluid system 14 which the detector 18 is attempting to detect. The pulse may be emitted in a verity of manners. For example, the pulse can be continuously emitted, semi-continuously emitted, or may be emitted in response to the detector 18 receiving a signal or detecting a change in the fluid system 14 (i.e., a temperature of the fluid system 14 dropping below a predetermined temperature). Further, the type, duration, amplitude or other property of the pulse may be shifted, altered or otherwise changed during operation of the pulse generator 22. It will be understood that the pulse may be shifted, altered and/or reflected based the properties (e.g., phase, temperature, pressure, fill level, speed, direction, etc.) of the fluid in the fluid system 14.

One or more of the detectors 18 may also include the pulse receiver 26. The pulse receiver 26 may be a microphone or other structure configured to detect a pulse generated by the pulse generator 22. Similarly to the pulse generator 22, the pulse receiver 26 may be directly coupled to any component of the fluid system 14 or may have one or more materials between the pulse receiver 26 and the fluid system 14 which is configured to transmit the pulse. The pulse receiver 26 may be configured to detect changes in properties of the pulse which indicate properties of the fluid. For example, the pulse receiver 26 or other components of the detector 18 may detect changes in the pulse emitted by the pulse generator 22 as compared to the pulse received by the pulse receiver 26 to detect properties such as phase, temperature, pressure, fill level, speed, and/or direction of the fluid in the fluid system 14. According to various examples, the pulse receiver 26 of one detector 18 may detect the pulse emitted by another detector 18. As such, one detector 18 may function as an emitter and another detector 18 may function as a receiver. In such an example, if fluid is flowing through the fluid system 14 the frequency of the pulse will change (i.e., due to the Doppler effect) and will be proportional to the fluid flow rate. This second detector 18 functioning as the receiver could then generate a signal and send the signal (i.e., such as pulse or an electromagnetic signal) back to the detector 18 functioning as the emitter, a home automation system 74 and/or external receiver 82.

According to various examples, a pair of detectors 18 may be positioned on a run of the fluid system 14. One detector 18 may have a pulse generator 22 and no pulse receiver 26 and the other detector 18 may have a pulse receiver 26 and no pulse generator 22. As such, the pair of detectors 18 may be used in tandem to detect properties of the fluid in the fluid system 14 without necessarily relying on reflected pulses.

One or more of the detectors 18 may also include the transmitter 30. The transmitter 30 may be a wired or wireless transmitter 30 configured to send signals between any one of the detectors 18 and/or the base station 34. Further, the transmitter 30 may also be configured to communicate or send signals to the home automation system 74. In wireless examples of the transmitter 30, the transmitter 30 may utilize Bluetooth®, WiFi™, radio frequency communication and/or combinations thereof. The transmitter 30 is configured to send one or more signals related to the detection of the pulse as explained in greater detail below. It will be understood that the transmitter 30 may be a transceiver such that the transmitter 30 may send and/or receive signals from the base station 34 and/or other detectors 18.

The base station 34 may be configured to be coupled to the fluid system 14. The base station 34 includes the receiver 38. The receiver 38 is in communication with the transmitter 30. As such, the receiver 38 may be configured to receive wired or wireless signals from the transmitter 30. Similarly to the transmitter 30, the receiver 38 may be a transceiver such that the receiver 38 may both send and receive signals.

The base station 34 is configured to cause a reduction of a flow of the fluid within the fluid system 14, trigger an alarm or cause an alarm to be triggered, or send a notification or cause a notification to be sent, in response to the receiver 38 receiving a signal from the transmitter 30 of the detector 18. In some embodiments, the detector 18, including the pulse generator 22 and the pulse receiver 26, is incorporated into the base station 34. The base station 34 may include a mechanical, electrical and/or electromechanical system coupled with the main line 50 of the fluid system 14. According to various examples, the base station 34 may be positioned proximate to or partially or fully integrated with the fluid source 46. As such, the base station 34 may reduce or terminate the flow of the fluid within the fluid system 14 in response to the receiver 38 receiving the signal from the transmitter 30 of the detector 18. For example, the base station 34 may be configured to block the mainline 50 and/or close a valve or other controller of the fluid source 46 and/or mainline 50 as explained in greater detail below. The base station 34 may further include a base transmitter 78 configured to transmit a base signal to the external receiver 82 and/or to the home automation system 74.

In some embodiments, at least one of the detectors 18 may the comprise a processor (not shown). In some embodiments, the base station 34 may comprise a processor. The processor may include memory. The processor may be configured to receive inputs from the pulse receiver 26 and to determine whether there has been a change in the reflected pulse or a transmitted pulse. The processor may be configured to compare a received input or inputs from the pulse receiver 26 to previously received inputs, and to determine whether there has been a change in the reflected pulse. A change in the reflected pulse may indicate, for example, a phase change such as freezing in the fluid in the fluid system 14. The received inputs may be based on the reflected pulse. If there has been a change in the reflected pulse the processor may be configured to generate a signal and cause the signal to be transmitted to one of the base station 34 and an external receiver. In some embodiments, the processor may be disposed within the base station 34. In some embodiments, the at least one detector, including the processor, the pulse receiver 26, and the pulse generator 22, may be disposed within or be integral to the base station 34.

In operation, the plumbing detection system 10 may be configured to detect and remediate plumbing issues that arise in the fluid system 14. In an initialization or set up example, the plumbing system 10 may be coupled to the fluid system 14 and allowed to learn or detect the standard operation of the fluid system 14. For example, in a residential plumbing application the plumbing detection system 10 may detect the time, volume, frequency and direction of fluid flow (e.g., dishwasher cycle, shower) in the fluid system 14. Further, the plumbing detection system 10 may determine how the pulse propagates in the fluid system 14 such that changes to the pulse (e.g., due to changes in the fluid) may be determined. Such information may be stored in one or more of the detectors 18, the base station 34, the home automation system 74 and/or the external receiver 82. During the initialization or set up example, the plumbing detection system 10 may sync or otherwise interface with one or more home automation systems 74 and/or external receivers 82 wirelessly and/or through a wired connection. The home automation system 74 may include one or more “smart home” components or may be a building control system. The external receiver 82 may be an offsite server, computer, cell phone tower or the like.

In a first example, the plumbing detection system 10 may be configured to detect and/or remediate phase changes of the fluid in the fluid system 14. For example, the pulse generator 22 may be configured to periodically (e.g., multiple times a second, once a second, once a minute, once an hour, etc.) emit the pulse into the fluid of the fluid system 14. As the pulse moves through the fluid, changes in phase, speed or direction may alter properties of the pulse and/or reflect the pulse such that the pulse detected at the pulse receiver 26 deviates from an expected value (i.e., the difference in the pulse after it had traveled through the fluid under known conditions from the set up examples). If the pulse detected by the pulse receiver 26 indicates that the fluid has solidified (i.e., water has frozen), a failure may have been experienced in one or more of components of the fluid system 14 (i.e., due to the expansion of the fluid). In response, the transmitter 30 may emit a signal to the base station 34 indicating that a potential malfunction has occurred. It will be understood that the transmitter 30 may additionally or alternatively emit the signal to another detector 18, the home automation system 74 and/or the external receiver 82. In response, the base station 34 may shut off the fluid source 46 (e.g., close a valve or a controller of the fluid source 46) or terminate flow within the fluid system 14 (i.e., block the main line 50). Such a feature may be advantageous in limiting the amount of fluid which may escape from the fluid system 14 once the fluid unfreezes. As the detector 18 and/or base station 34 may alert the home automation system 74 and/or the external receiver 82, the home automation system 74 and/or the external receiver 82 may in turn notify an owner, occupant or user of the structure in which the fluid system 14 is housed.

In a second example, the plumbing detection system 10 is configured to detect anomalous fluid. For example, if the plumbing detection system 10 detects that fluid speed, direction or volume within a portion of the fluid system 14 deviate from normal usage patterns (i.e., fluid flow to a washing machine has gone longer than typical or a volume of fluid to a sink is greater than previously recorded values), one or more of the detectors 18 may send a signal to the base station 34, home automation system 74 and/or external receiver 82 such that an owner or operator of the structure in which the fluid system 14 is housed may be notified. Further, the base station 34 may terminate fluid flow in the fluid system 14 by disabling the fluid source 46.

In a third example, the plumbing detection system 10 is configured to detect fluid flow when fluid should not be flowing. For example, if a user will be away for a period of time, the user may set the plumbing detection system 10 to a vacation mode or similar mode. If the plumbing detection system 10 detects fluid flow when there should not be any, the plumbing detection system 10 may be configured to disable the fluid source 46 and/or to send an alert to at least one of either the home automation system 74 and the external receiver 82.

It will be understood that the detectors 18 and/or the base station 34 may communicate through the pulse. For example, the pulse generator 22 of one detector 18 may encode a message in the pulse (i.e., changes in frequency, amplitude, duration, number of pulses) which may be received and decoded by the pulse receiver 26 of a different detector 18 or in examples of the base station 34 including a pulse receiver 26. Such a feature may be advantageous in potentially eliminating superfluous communication components from the plumbing detection system 10.

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise. Further, the claims, as set forth below,

What is claimed is:

1. A plumbing detection system, comprising:
a detector configured to be coupled to a fluid system, comprising:
a pulse generator configured to emit a pulse into a fluid within the fluid system; and
a transmitter in communication with the pulse generator; and
a base station configured to be coupled to the fluid system; wherein the base station comprises a receiver in communication with the transmitter; and wherein the base station is configured to cause a reduction of a flow of the fluid within the fluid system in response to the receiver receiving a signal from the transmitter of the detector.

2. The plumbing detection system of claim 1, wherein the detector further comprises a pulse receiver configured to detect a reflected pulse and in communication with the pulse generator and the transmitter.

3. The plumbing detection system of claim 1, further comprising a second detector in communication with configured to be coupled to a fluid system, the second detector comprising:
a second pulse generator configured to emit a pulse into the fluid within the fluid system; and
a second transmitter;
wherein the base station is configured to be in communication with the second transmitter.

4. The plumbing detection system of claim 1, further comprising a processor in communication with the pulse receiver; wherein the processor is configured to determine whether a phase change has occurred in the fluid of the fluid system.

5. The plumbing detection system of claim 4, wherein the processor is configured to cause a signal to be generated and transmitted to at least one of the base station and an external receiver upon a determination that a phase change has occurred in the fluid of the fluid system.

6. The plumbing detection system of claim 1, wherein the pulse is an audio frequency of from about 0.1 Hz to about 1 GHz.

7. The plumbing detection system of claim 1, wherein the fluid is water, and wherein the fluid system is a plumbing system.

8. The plumbing detection system of claim 1, wherein the transmitter is a wireless transmitter.

9. The plumbing detection system of claim 1, wherein the base station is configured to terminate the flow of the fluid within the fluid system in response to the receiver receiving the signal from the transmitter of the detector.

10. The plumbing detection system of claim 1, wherein the base station comprises a base transmitter configured to transmit a base signal to an external receiver.

11. The plumbing detection system of claim 9, wherein the external receiver is a cell phone tower.

12. The plumbing detection system of claim 1, wherein the base station is coupled to a valve of a fluid source.

13. A plumbing detector configured to be coupled to a fluid system, comprising:
a pulse generator configured to emit a pulse into a fluid within the fluid system;
a pulse receiver configured to detect at least one of a reflected pulse and a transmitted pulse, and in communication with the pulse generator;
a processor in communication with the pulse receiver; and
a controller in communication with the processor.

14. The plumbing detector of claim 13, wherein the pulse generator and the pulse receiver are embodied in a piezo-electric element.

15. The plumbing detector of claim 13, wherein the processor is configured to determine whether there has been a change in the reflected pulse; and
wherein the processor is configured to selectively cause the controller to stop fluid flow within the fluid system in response to information received from the pulse receiver.

16. The plumbing detection system of claim 13, wherein the fluid is water, and wherein the fluid system is a plumbing system.

17. The plumbing detector of claim 13, wherein the processor is configured to:
compare a received pulse to a previously received pulse; and
determine whether there has been a change in the reflected pulse received by the pulse receiver.

18. The plumbing detector of claim 17, wherein the plumbing detector is configured to generate a signal in response to a change in the reflected pulse received by the pulse receiver.

19. The plumbing detector of claim 13, further comprising a transmitter in communication with an external receiver, the transmitter configured to transmit a signal to the external receiver upon a change in the reflected pulse received by the pulse receiver.

20. The plumbing detector of claim 13, wherein the pulse is emitted in response to the detector detecting a change in the fluid system.
